(19) United States
(12) Patent Application Publication
(10) Pub. No.: US 2026/0121394 A1
(43) Pub. Date: Apr. 30, 2026

(54) CABLE GLAND SYSTEM

(71) Applicant: AggieTech Capital LLC, Midland, TX (US)

(72) Inventors: Marshall Bales, Midland, TX (US); Wesley Armstrong, Lufkin, TX (US)

(73) Assignee: AggieTech Capital LLC, Midland, TX (US)

(21) Appl. No.: 18/926,928

(22) Filed: Oct. 25, 2024

(51) Int. Cl. H02G 15/30

(52) U.S. Cl. CPC H02G 15/30

(57) ABSTRACT

A cable gland system for an armored cable is disclosed. The system may include a housing, a first insulating layer, a second insulating layer and an elastomer gland. The housing may include a first portion and a second portion. The first insulating layer may be disposed in the first portion, and the second insulating layer may be disposed in the second portion. The elastomer gland may be disposed in the housing between the first insulating layer and the second insulating layer. The first insulating layer, the elastomer gland and the second insulating layer may receive a unified insulated conductor of the armored cable. Further, the elastomer gland may secure the unified insulated conductor via an interference fit in an elastomer gland interior portion.

### TECHNICAL FIELD

The present disclosure relates to a cable gland system, and more specifically to a cable gland system that secures one or more insulated conductors in an interior portion of a cable gland system.

### BACKGROUND

A cable gland is used to mechanically secure or seal a cable passing through an opening of a structure or a junction box, especially in hazardous environments. For example, a cable gland may be used to seal a cable in proximity to or at a wellhead system, when the cable transfers energy from an electric source to equipment placed inside a well. A wellhead system is a primary point of ingress or egress to the closed and corrosive environment associated with the well in which the electrical equipment may be placed.

In the oil and gas industry, since the electrical equipment is placed inside the well that may have high temperature, high pressure environment, it is desirable that discontinuities in the cable that transfer energy to the electrical equipment are minimized.

A conventional cable gland that seals the cable may require an operator to connect a conductor of the incoming cable to an electrical connector in the cable gland. Such an electrical connection in the cable gland may become a point of failure over time and may hence disrupt the transfer of energy to the electrical equipment that receives power via the cable. More particularly, such discontinuities may become points of failure when the cable transfers energy to the electrical equipment in the well, and may hence disrupt the energy transfer.

In light of this, it is advantageous to provide a cable gland system that reduces the number of discontinuities in the cable connecting an electric source to an electrical equipment.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a front view of an example cable gland system in accordance with the present disclosure.

FIG. 2 depicts an isometric view of an example cable gland system in a disassembled state without a housing in accordance with the present disclosure.

FIG. 3 depicts a cross-sectional view of an example cable gland system in accordance with the present disclosure.

FIG. 4 depicts a perspective cross-sectional view of a portion of an example cable gland system in accordance with the present disclosure.

FIG. 5 depicts an isometric view of a cable gland in accordance with the present disclosure.

### DETAILED DESCRIPTION

### Overview

The present disclosure describes a cable gland system (“system”) that may secure/seal an armored cable that transfers energy from an electrical energy source to an electrical equipment through a wellhead system. The electrical equipment may be disposed in a well, and the wellhead system may be a point of ingress or egress to the well. The system may be located at or in proximity to the wellhead system, and may protect the cable from the mechanical strains and harsh environment associated with the well.

In an exemplary aspect, the armored cable may include one or more conductors, which may be insulated by an insulator. A conductor insulated by an insulator is referred to as an “insulated conductor” in the present disclosure. Further, in the armored cable, the insulated conductor may be enclosed by an armor, which may further be enclosed by a sheath. The armored cable may include one or more additional layers, depending on the cable usage requirements.

In some aspects, an operator may first remove the sheath and then the armor from the cable, and then insert the exposed insulated conductors into the system, to secure/seal the insulated conductors from the mechanical strains and harsh environment associated with the well. The system may include a plurality of components that may efficiently and securely seal the insulated conductors, as described below.

In some aspects, the system may include a cylindrical hollow housing having a first portion (or a bottom portion) and a second portion (or a top portion). The system may further include a first insulating layer disposed in the first portion and a second insulating layer disposed in the second portion. The first and second insulating layers may include one or more channels through which the insulated conductors may pass, when the operator inserts the insulated conductors into the system.

The system may further include an elastomer gland that may be disposed between the first and second insulating layers. The elastomer gland may be made of silicon, and may include one or more apertures and one or more cylindrical receptacles disposed on top and bottom surfaces of the elastomer gland over the apertures. The apertures and the cylindrical receptacles may enable the insulated conductors to pass through, when the operator inserts the insulated conductors into the system. Further, the cylindrical receptacles may secure/seal the insulated conductors via interference fit when the insulated conductors are disposed inside the cylindrical receptacles/elastomer gland.

The system may further include a cam actuator that may be disposed on a housing's exterior surface. The actuator may radially move between a first position (e.g., a “locked” position) and a second position (e.g., an “unlocked” position). The actuator may “squeeze” the first insulating layer when the actuator is in the first position, which in turn may cause the cylindrical receptacles to apply an additional inward circumferential pressure/force on the insulated conductors (and hence further seal the insulated conductors within the system). Therefore, the operator may cause the elastomer gland/system to further secure and seal the insulated conductors when the operator moves the actuator to the first position.

The system may additionally include an elastomeric guard that may enclose (and hence protect) the armor associated with the cable, when the operator removes the armor and inserts the insulated conductors into the system interior portion.

The present disclosure discloses a cable gland system that provides environmental protection to the cable's insulated conductors by forming a hermetic seal between the cable, its external sheathing and the elastomer gland. The hermetic seal prevents any corrosive liquids or gases from contacting the insulated conductors or the conductors themselves and provide protection from rapid decompression. The system further enables uninterrupted transmission of energy from the electrical source to the electrical equipment in the well, while protecting the wellhead system and equipment from peak voltage and current. The system additionally ensures that no cable pullout can be achieved by mechanical forces acting upon the cable under normal operation. The system further seals/protects the cable from the high pressure area below the wellhead system and between the wellhead system and cable gland, preventing any emissions to the environment.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

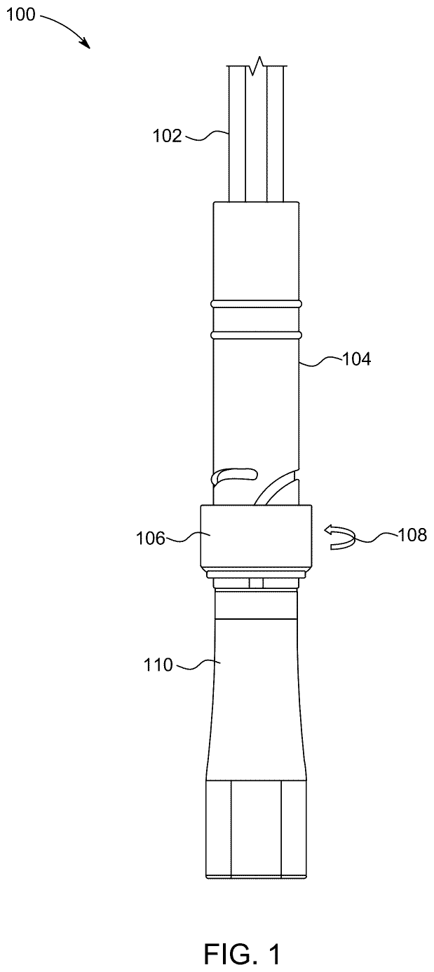

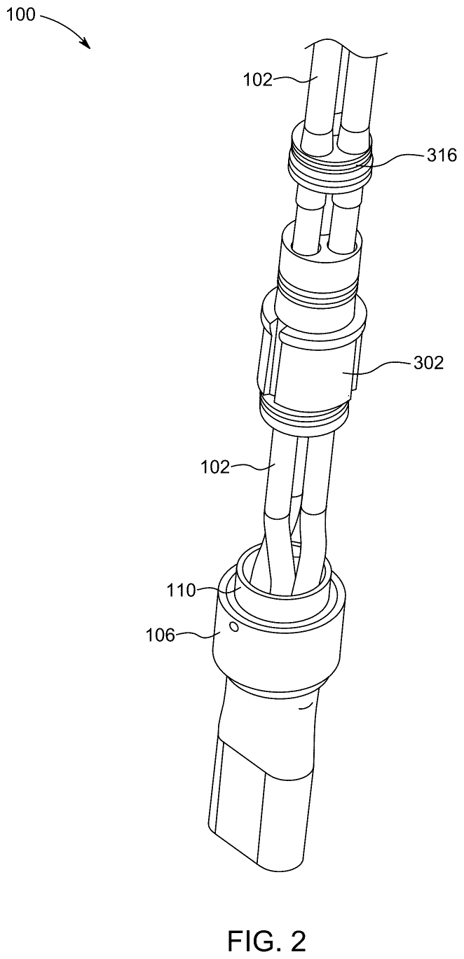

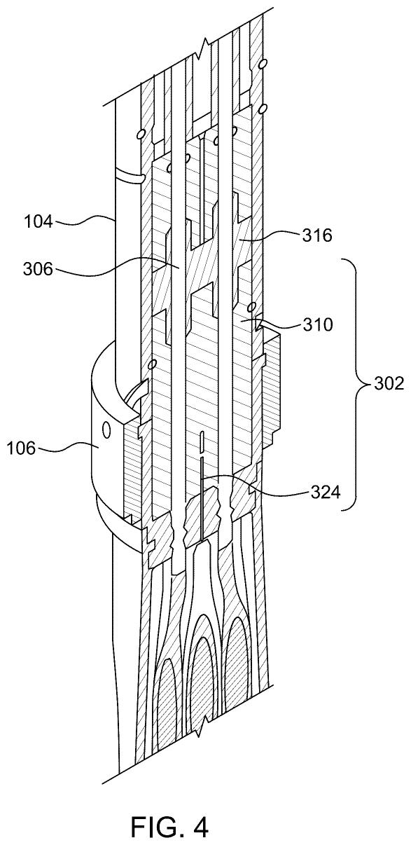

FIG. 1 depicts a front view of an example cable gland system 100 (or system 100) in accordance with the present disclosure. FIG. 1 will be described in conjunction with FIGS. 2, 3, 4, and 5.

In some aspects, an operator may use the system 100 to secure or seal a cable 102 (which may be an armored electrical cable) that may transmit energy through a wellhead system (not shown) from an electrical source to one or more electrical equipment that may be placed in a well (e.g., an oil well). Since an oil well may have high temperature, high pressure environment, it is typical for the operators to use armored cables to transmit energy from the electrical source to the electrical equipment (e.g., motors, sensors, etc.) placed in the well. An armored cable may include any number of conductors that may be insulated by various materials, typically in layers, and protected by a hard steel cladding or similar. A person ordinarily skilled in the art may appreciate that an armored cable (e.g., the cable 102) may include one or more conductors, which may be insulated by an insulator. A conductor insulated by an insulator is referred to as an “insulated conductor” in the present disclosure. Further, in an armored cable (e.g., the cable 102), the insulated conductor may be enclosed by an armor, which may further be enclosed by a sheath. The armored cable may include one or more additional layers, depending on the cable usage requirements.

The system 100 may secure the cable 102 such that the cable 102 may withstand the harsh environment and/or mechanical stress in proximity to the wellhead system. The system 100 may facilitate the operator to secure the cable 102 in the system 100 without having to electrically connect the cable conductors to any electrical connector inside the system 100. In this manner, the system 100 facilitates in reducing the count of discontinuities in the cable connection from the electrical source to the electrical equipment in the well, and hence facilitates in reducing the potential points of failure in the cable connection. The system 100 may be used with different types and/or sizes of wellhead systems and may be reused over multiple installations.

In other aspects, the operator may use the system 100 to secure the cable 102 in other environments and/or electrical connections. Stated another way, the system 100 usage is not limited to the environments that contain wellhead systems.

The system 100 may include a housing 104 that may be made of metallic or non-metallic material. For example, the housing 104 may be made of aluminum, plastic, steel, and/or the like. In some aspects, the housing 104 may be cylindrical in shape, with a diameter that may correspond to or greater than the cable 102 diameter. The housing 104 may act as a conduit for the cable conductors passing through the wellhead system. The housing 104 may further provide a mechanical seal between a cable gland disposed inside the system 100 (described later in the description below) and the wellhead mandrel or hanger, and/or one or more wellhead system components. The housing 104 may additionally provide a level of protection for the cable conductors from the environment within the well, based on the material selection and coatings that may be applied on the housing 104.

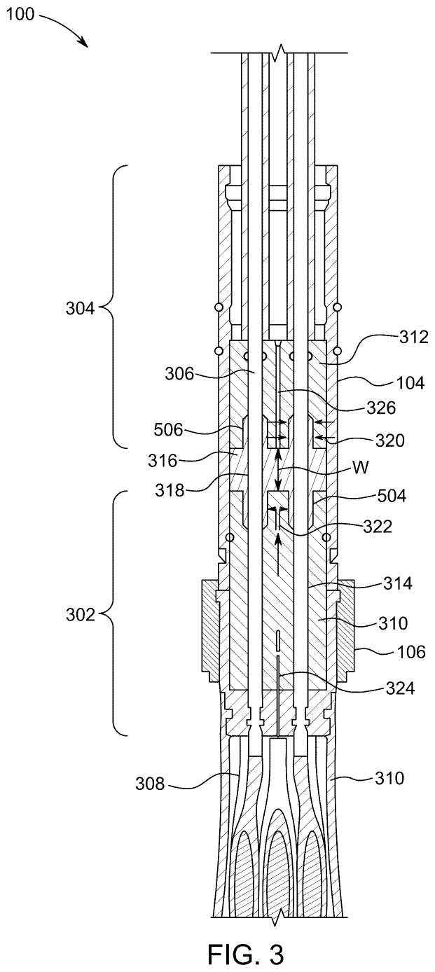

The housing 104 may include a first portion 302 and a second portion 304, as shown in the system's cross-sectional view depicted in FIG. 3. In an exemplary aspect, the first portion 302 may be disposed towards a housing's bottom side, through which the operator may insert the cable 102 (specifically insulated conductors 306 of the cable 102) into the system 100/housing 104. Specifically, to secure the cable 102 in the system 100, the operator may first remove or peel-off an armor 308 from the cable 102 (after removing the cable sheath) to expose the insulated conductors 306. The operator may then insert the insulated conductors 306 into the first portion 302 via the housing's bottom side.

The second portion 304 may be disposed towards a housing's top side, through which the insulated conductors 306 may move out of the system 100 (from where the operator may connect the insulated conductors 306 to one or more wellhead system components or electrical equipment). In some aspects, the first and second portions 302, 304 may have equivalent volumes, which may each be in a range of 30-40% of a housing volume. In other aspects, the first and second portions 302, 304 may have different volumes.

The system 100 may further include a first insulating layer 310 disposed in the first portion 302 and a second insulating layer 312 disposed in the second portion 304. In some aspects, the first and second insulating layers 310, 312 may fill the entire volumes of the first and second portions 302, 304 respectively. In other aspects, the first and second insulating layers 310, 312 may fill parts of the first and second portions' volumes, as shown in FIG. 3. The first and second insulating layers 310, 312 may be made of the same material, which may be, for example, a thermoplastic polymer. It may be appreciated that thermoplastic polymers are used as sealants to protect against ambient environment and/or moisture. In an exemplary aspect, the first and second insulating layers 310, 312 are made of polyketone.

In some aspects, the first and second insulating layers 310, 312 may include one or more channels 314 through which the insulated conductors 306 may pass. A channel diameter may be equivalent to an insulated conductor diameter. The system 100 may further include an elastomer gland 316 disposed in the housing 104 between the first insulating layer 310 and the second insulating layer 312, as shown in FIG. 3. Stated another way, the elastomer gland 316 may be disposed between the first and second portions 302, 304, which include the first and second insulating layers 310, 312. In an exemplary aspect, the elastomer gland 316 may be made of silicon, or any other similar flexible material. In some aspects, the elastomer gland 316 may be disposed in the housing 104 between the first insulating layer 310 and the second insulating layer 312 such that the first insulating layer 310 may cover an entire elastomer gland's bottom surface and the second insulating layer 312 may cover an entire elastomer gland's top surface.

The first insulating layer 310, the elastomer gland 316 and the second insulating layer 312 may receive a unified insulated conductor 306 of the armored cable 102, and enable the operator to pass the cable 102 from the electrical source to the wellhead system/electrical equipment via the system 100 without any discontinuity within the system 100. Stated another way, the operator may not be required to cut the insulated conductor 306 and electrically connect the insulated conductor 306 with any electrical connector within the system 100 (as is the case with conventional cable gland systems), when the operator secures/seal the insulator conductor 306 in the system 100. The operator may simply pass an uncut, unified insulator conductor 306 via the first insulating layer 310, the elastomer gland 316 and the second insulating layer 312 to seal the insulator conductor 306 in the system 100, and enable the transfer of energy from the electrical source to the wellhead system/electrical equipment via the cable 102 without increasing the number of discontinuities or potential points of failure in the electrical line.

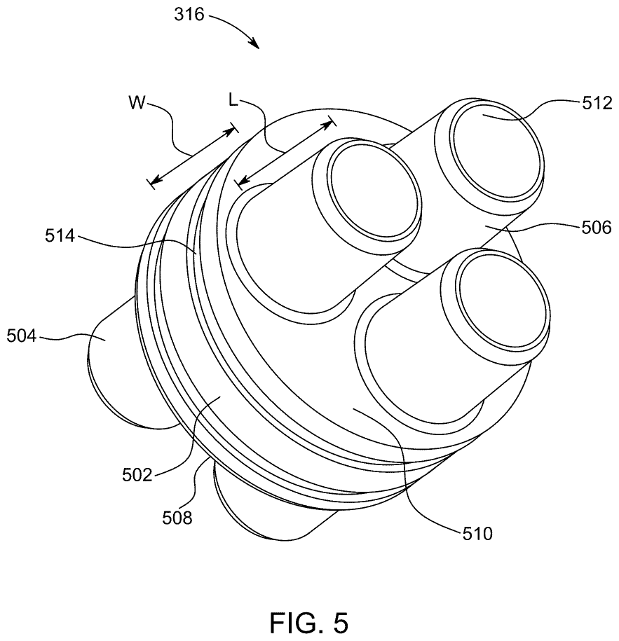

An elastomer gland's isometric view is shown in FIG. 5. In some aspects, the elastomer gland 316 may be cylindrical in shape, having a cylindrical body 502. A cylindrical body diameter may be equivalent to an interior diameter associated with the housing 104. Specifically, the cylindrical body diameter may correspond to the interior diameter of a housing portion that is disposed between the first and second portions 302, 304 (where the elastomer gland 316 may be located). The cylindrical body 502 may include one or more apertures 318 disposed along an entire cylindrical body width “W” (shown in FIG. 3). An aperture diameter may be equivalent to an insulated conductor diameter. The operator may slide/pass the insulated conductor 306 through the elastomer gland 316 via the aperture 318.

The elastomer gland 316 may further include one or more first hollow cylindrical receptacles 504 and one or more second hollow cylindrical receptacles 506. FIG. 5 depicts an example aspect where the elastomer gland 316 includes three second hollow cylindrical receptacles 506 (and three first hollow cylindrical receptacles 504); however, the present disclosure is not limited to such an aspect. The elastomer gland 316 may include more or less than three first and second hollow cylindrical receptacles 504, 506 depending on a count of insulated conductors 306 that are present in the cable 102. In some aspects, the count of first and second hollow cylindrical receptacles 504 in the elastomer gland 316 is equivalent to the count of insulated conductors 306 that the operator desires to slide/pass through the system 100.

Each first hollow cylindrical receptacle 504 may be disposed on a bottom surface 508 of the cylindrical body 502 (that faces and is in touch with the first insulating layer 310) over the aperture 318 (specifically an aperture bottom side that faces the first insulating layer 310). A diameter associated with the first hollow cylindrical receptacle 504 may be equivalent to the aperture diameter (which may be equivalent to the insulated conductor diameter, as described above). Further, the circular walls and the central axis of the first hollow cylindrical receptacle 504 may be aligned with the circular aperture walls and central axis.

Similarly, each second hollow cylindrical receptacle 506 may be disposed on a top surface 510 of the cylindrical body 502 (that faces and is in touch with the second insulating layer 312) over the aperture 318 (specifically an aperture top side that faces the second insulating layer 312). A diameter associated with the second hollow cylindrical receptacle 506 may be equivalent to the aperture diameter. Further, the circular walls and the central axis of the second hollow cylindrical receptacle 506 may be aligned with the circular aperture walls and central axis.

When the operator inserts the insulated conductor 306 in the elastomer gland 316, the insulated conductor 306 may pass through the first hollow cylindrical receptacle 504, and then the aperture 318, and finally through the second hollow cylindrical receptacle 506.

In some aspects, a length “L” of each second hollow cylindrical receptacle 506 may be equivalent to the length of each first hollow cylindrical receptacle 504, which in turn may be equivalent to the width “W”. In other aspects, the length “L” may be different from the width “W”. Since the first hollow cylindrical receptacle 504 is disposed on the bottom surface 508 and over the aperture 318, the first hollow cylindrical receptacle 504 protrudes into the first portion 302 or into the first insulating layer 310. Consequently, the first insulating layer 310 encloses an exterior surface/periphery associated with the first hollow cylindrical receptacle 504. Similarly, since the second hollow cylindrical receptacle 506 is disposed on the top surface 510 and over the aperture 318, the second hollow cylindrical receptacle 506 protrudes into the second portion 302 or into the second insulating layer 312. Consequently, the second insulating layer 312 encloses an exterior surface/periphery associated with the second hollow cylindrical receptacle 506.

The elastomer gland 316 may secure the insulated conductor 306 via an interference fit in an elastomer gland interior portion when the operator slides/passes the insulated conductor 306 through the system 100 (i.e., through the first insulating layer 310, the elastomer gland 316 and the second insulating layer 312). Specifically, when the operator slides/passes the insulated conductor 306 through the system 100, an interior surface associated with the first hollow cylindrical receptacle 504, an interior surface 512 associated with the second hollow cylindrical receptacle 506 and aperture walls may secure the insulated conductor 306 via interference fit by applying an inward circumferential pressure/force (shown by arrows 320 in FIG. 3) on an exterior surface associated with the insulated conductor 306. The interference fit/inward circumferential pressure may robustly secure the insulated conductor 306 in the elastomer gland 316, and may hence seal the elastomer gland 316/cable 102 inside the system 100. In some aspects, the operator may first expand the various openings of the elastomer gland 316 (e.g., the openings of the first and second hollow cylindrical receptacles 504, 506 and the aperture 318) via a specialized expansion tool (not shown), and then insert/slide the insulated conductor 306 in the elastomer gland 316. This may facilitate the operator in conveniently sliding/inserting the insulated conductor 306 into the elastomer gland 316, before the elastomer gland 316 secures the insulated conductor 306 via interference fit/inward circumferential pressure, as described above.

It may be appreciated that in addition to the inward circumferential pressure that the elastomer gland 316 applies to the insulated conductor 306, the channels 314 present in the first and second insulating layers 310, 312 (through which the insulated conductor 306 passes) may also apply an inward circumferential pressure on the insulated conductor 306, thus providing additional sealing or strain relief to the insulated conductor 306. In this manner, the elastomer gland 316 may provide a first sealing/strain relief to the insulated conductor 306 and the channels 314 may provide a second sealing/strain relief to the insulated conductor 306, when the insulated conductor 306 passes through the system 100. This enables the operator to robustly seal/secure the insulated conductor 306 in the system 100, without having to cut the insulated conductor 306 anywhere inside the system 100. The system 100 may include one or more additional components that may facilitate in further securing the insulated conductor 306 in the system 100 in a more efficient manner, as described below.

In some aspects, the system 100 may additionally include an actuator 106 (which may be a cam actuator or a cam locking mechanism) that may be disposed on an exterior surface of the housing 104, as shown in FIGS. 1, 2, 3 and 4. In an exemplary aspect, the actuator 106 may be disposed on the exterior surface of the first portion 302. The actuator 106 may be configured to move between a first position (i.e., a “locked” position) and a second position (i.e., an “unlocked” position). The actuator 106 may radially move (as shown by an arrow 108 in FIG. 1) on the housing's exterior surface by a predefined angle to move between the first position and the second position. Specifically, the operator may radially move the actuator 106 clockwise (or counterclockwise) by the predefined angle to cause the actuator 106 to move between the first position and the second position. In an exemplary aspect, the predefined angle may be 90 degrees. In other aspects, the predefined angle may be less than 90 degrees (e.g., 45 degrees or 60 degrees).

The actuator 106 may squeeze the first insulating layer 310 “upwards” towards the bottom surface 508 associated with the cylindrical body 502 when the actuator 106 is in the first position, and may not squeeze the first insulating layer 310 towards the bottom surface 508 when the actuator 105 is in the second position. When the actuator 106 squeezes the first insulating layer 310 upwards towards the bottom surface 508, the “squeezed” first insulating layer 310 may apply an inward force on the exterior surface of the first hollow cylindrical receptacle 504, as shown by arrows 322 in FIG. 3. This inward force may transfer onto the insulated conductor 306 placed inside the first hollow cylindrical receptacle 504. In this manner, the first hollow cylindrical receptacle 504 may apply an additional inward circumferential pressure/force (in addition to the interference fit described above) on the exterior surface of the insulated conductor 306 when the actuator 106 is in the first position, thereby enabling the first hollow cylindrical receptacle 504 to further “compress” or secure the insulated conductor 306 in the elastomer gland 316. In some aspects, the squeezed first insulating layer 310 may apply an inward force in the channels 314 as well, which may further secure the insulated conductor 306 in the channels 314. The operator may radially move the actuator 106 to the first position after the operator has placed/inserted the insulator conductor 306 in the first insulating layer 310, the elastomer gland 316 and the second insulating layer 312, to further secure/seal the insulated conductor 306 in the elastomer gland 316 and the channels 314.

The system 100 may include one or more additional components that may enhance the user experience of using/operating the system 100 to secure or seal the cable 102. For example, the system 100 may include a first elongated cavity 324 (or a first orifice or pathway) disposed in the first insulating layer 310 along a first insulating layer length and a second elongated cavity 326 (or a second orifice or pathway) disposed in the second insulating layer 312 along a second insulating layer length, as shown in FIG. 3. The first and second elongated cavities 324, 326 may enable trapped gases in the first and second insulating layers 310, 312 to escape when the operator inserts the insulator conductor 306 in the first insulating layer 310, the elastomer gland 316 and the second insulating layer 312, and/or when the operator radially moves the actuator 106 to the first position (e.g., when the first insulating layer 310 gets squeezed). The first and second elongated cavities 324, 326 may further enable the operator to inject thermoplastic or resin in these cavities to accommodate for change in conductor sizes, while in the field.

In some aspects, the system 100 may further include one or more grooves 514 (as shown in FIG. 5) disposed along the circumference of the cylindrical body 502 associated with the elastomer gland 316. The grooves 514 may receive one or more O-rings (not shown) to secure the elastomer gland 316 in the housing 104. Specifically, the operator may add the O-rings in the grooves 514 and then place the elastomer gland 316 in the housing 104, if the elastomer gland 316 diameter may be slightly different than the housing interior surface diameter (e.g., due to wear and tear, thermal expansion, etc.). The O-rings may enable the operator to securely place/attach the elastomer gland 316 in the housing 104 between the first and second portions 302, 304, as described above.

The system 100 may further include an elastomeric guard 110 disposed below the first portion 302, as shown in FIGS. 1, 2, 3 and 4. The elastomeric guard 110 may enclose (and hence protect) the cable armor 308, when the operator removes the cable armor 308 from the cable 102 and inserts the insulated conductor 306 into the first insulating layer 310, the elastomer gland 316 and the second insulating layer 312 to secure/seal the insulated conductor 306, as described above. In this manner, the system 100 not only secures/seals the insulated conductor 306, but also protects the cable armor 308 that the operator removes from the cable 102.

In operation, the operator may first remove the external sheath and the cable armor 308 from the cable 102 to expose the insulator conductor 306 that is required to be secured/sealed in the system 100. The operator may remove the sheath and the cable armor 308 to reduce the cable's cross-sectional area passing through the wellhead system. The operator may then “expand” the openings associated with the elastomer gland 316 by using a specialized tool (as described above), and insert/slide the insulator conductor 306 through the expanded elastomer gland 316. Once the insulator conductor 306 is inside the elastomer gland 316, the gland's inward compressive forces may provide proper strain relief and sealing for the insulator conductor 306.

The operator may additionally pass the insulated conductor 306 through the channels 314 associated with the first and second insulating layers 310, 312, to secure the insulator conductor 306 in the system 100, as described above. The operator may further attach/add the elastomeric guard 110 to secure the cable armor 308. The operator may then radially move the actuator 106 to the first position to further secure the insulated conductor 306 in the system 100, as described above.

The system 100, as described in the present disclosure, provides a reusable and economical means to reduce or eliminate the number of discontinuities between the electrical source and the equipment or device within a well. The system 100 provides mechanical strain relief to the insulated conductor 306 and a full hermetic seal to the insulated conductor 306 when the cable's external sheathing has been removed, thereby preventing breakage and increasing the level of protection for individual conductor insulation and sealing against high pressures inside the well.

The system 100 provides various benefits and advantages to the operator. For example, the system 100 provides environmental protection to the insulated conductor 306 by forming a hermetic seal between the cable 102, its external sheathing and the elastomer gland 316. The hermetic seal prevents any corrosive liquids or gases from contacting the insulated conductors 306 or the conductors themselves and provide protection from rapid decompression. The system 100 further enables uninterrupted transmission of energy from the electrical source to the electrical equipment in the well, while protecting the wellhead system and equipment from peak voltage and current. The system 100 additionally ensures that no cable pullout can be achieved by mechanical forces acting upon the cable under normal operation. The system 100 further seals/protects the cable 102 from high pressure area below the wellhead system and between the wellhead system and cable gland, preventing any emissions to the environment.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A cable gland system for an armored cable, the cable gland system comprising:
a housing comprising a first portion and a second portion;
a first insulating layer disposed in the first portion and a second insulating layer disposed in the second portion; and
an elastomer gland disposed in the housing between the first insulating layer and the second insulating layer, wherein:
the first insulating layer, the elastomer gland and the second insulating layer are configured to receive a unified insulated conductor of the armored cable, and
the elastomer gland secures the unified insulated conductor via an interference fit in an elastomer gland interior portion.

2. The cable gland system of claim 1, wherein the elastomer gland is cylindrical in shape, and wherein the elastomer gland comprises:
a cylindrical body comprising an aperture disposed along a cylindrical body width;
a first hollow cylindrical receptacle disposed on a bottom surface of the cylindrical body over the aperture; and
a second hollow cylindrical receptacle disposed on a top surface of the cylindrical body over the aperture.

3. The cable gland system of claim 2, wherein an interior surface of the first hollow cylindrical receptacle, an interior surface of the second hollow cylindrical receptacle and aperture walls are configured to secure the unified insulated conductor via the interference fit by applying an inward circumferential pressure on an exterior surface of the unified insulated conductor.

4. The cable gland system of claim 2, wherein the first insulating layer encloses an exterior surface of the first hollow cylindrical receptacle, and wherein the second insulating layer encloses an exterior surface of the second hollow cylindrical receptacle.

5. The cable gland system of claim 2 further comprising an actuator disposed on an exterior surface of the housing, wherein the actuator is configured to move between a first position and a second position.

6. The cable gland system of claim 5, wherein the actuator is configured to squeeze the first insulating layer towards the bottom surface of the cylindrical body when the actuator is in the first position, and wherein the actuator is configured to not squeeze the first insulating layer towards the bottom surface of the cylindrical body when the actuator is in the second position.

7. The cable gland system of claim 6, wherein the first hollow cylindrical receptacle is configured to apply an additional inward circumferential pressure on an exterior surface of the unified insulated conductor when the actuator is in the first position.

8. The cable gland system of claim 5 wherein the actuator is configured to radially move on the exterior surface by a predefined angle to move between the first position and the second position.

9. The cable gland system of claim 8, wherein the predefined angle is 90 degrees.

10. The cable gland system of claim 5, wherein the actuator is disposed on the exterior surface of the first portion.

11. The cable gland system of claim 1 further comprising a first elongated cavity disposed in the first insulating layer along a first insulating layer length and a second elongated cavity disposed in the second insulating layer along a second insulating layer length, wherein the first elongated cavity and the second elongated cavity are configured to enable trapped gases to escape the first insulating layer and the second insulating layer when the first insulating layer, the elastomer gland and the second insulating layer receive the unified insulated conductor.

12. The cable gland system of claim 1 further comprising an elastomeric guard configured to enclose an armor of the armored cable, when the first insulating layer, the elastomer gland and the second insulating layer receive the unified insulated conductor.

13. The cable gland system of claim 12, wherein the elastomeric guard is disposed below the first portion.

14. The cable gland system of claim 1 further comprising one or more grooves disposed along a circumference of the elastomer gland, wherein the one or more grooves are configured to receive one or more O-rings to secure the elastomer gland in the housing.

15. The cable gland system of claim 1, wherein the elastomer gland is made of silicon.

16. The cable gland system of claim 1, wherein the housing is cylindrical in shape.

17. The cable gland system of claim 1, wherein the first insulating layer and the second insulating layer are made of a thermoplastic polymer.

18. The cable gland system of claim 1, wherein the first insulating layer and the second insulating layer are made of polyketone.

19. A cable gland system for an armored cable, the cable gland system comprising:
a housing comprising a first portion and a second portion;
a first insulating layer disposed in the first portion and a second insulating layer disposed in the second portion;
an elastomer gland disposed in the housing between the first insulating layer and the second insulating layer, wherein:
the first insulating layer, the elastomer gland and the second insulating layer are configured to receive a unified insulated conductor of the armored cable, and
the elastomer gland secures the unified insulated conductor via an interference fit in an elastomer gland interior portion; and
an actuator disposed on an exterior surface of the housing, wherein the actuator is configured to move between a first position and a second position, and wherein the actuator is configured to enable the elastomer gland to apply an additional inward circumferential pressure on an exterior surface of the unified insulated conductor when the actuator is in the first position.

20. A cable gland system for an armored cable, the cable gland system comprising:
a housing comprising a first portion and a second portion;
a first insulating layer disposed in the first portion and a second insulating layer disposed in the second portion;
an elastomer gland disposed in the housing between the first insulating layer and the second insulating layer, wherein:
the first insulating layer, the elastomer gland and the second insulating layer are configured to receive a unified insulated conductor of the armored cable, and
the elastomer gland secures the unified insulated conductor via an interference fit in an elastomer gland interior portion; and
a first elongated cavity disposed in the first insulating layer along a first insulating layer length and a second elongated cavity disposed in the second insulating layer along a second insulating layer length, wherein the first elongated cavity and the second elongated cavity are configured to enable trapped gases to escape the first insulating layer and the second insulating layer when the first insulating layer, the elastomer gland and the second insulating layer receive the unified insulated conductor.
